(19) United States
(12) Patent Application Publication
(10) Pub. No.: US 2026/0316658 A1
(43) Pub. Date: Oct. 15, 2026

(54) VARIABLE REFRIGERATION TOWER

(71) Applicant: SPEED FLOOR CO.,LTD, Incheon (KR)

(72) Inventor: Hyun Jin HONG, Incheon (KR)

(73) Assignee: SPEED FLOOR CO.,LTD, Incheon (KR)

(21) Appl. No.: 18/870,248

(22) PCT Filed: Jan. 4, 2024
(86) PCT No.: PCT/KR2024/000167

§ 371 Date: Nov. 27, 2024

(30) Foreign Application Priority Data
Dec. 8, 2023 (KR) 10-2023-0177697

(51) Int. Cl. B60P 3/20; B65G 67/04; B65G 69/00

(52) U.S. Cl. CPC B60P 3/20; B65G 67/04; B65G 69/00

(57) ABSTRACT

The present disclosure relates to a variable refrigeration tower, and includes at least: a cargo horizontal loading and unloading unit horizontally moving in a loading space inside a loading box of a cargo vehicle, a bulkhead plate vertically mounted on the loading space and horizontally moving inside the loading space, an outdoor unit, an indoor unit disposed in the bulkhead plate, moving along the bulkhead plate and discharging cold air into a first space partitioned by the bulkhead plate in the loading space, a cold circulation line connecting the outdoor unit and the indoor unit and following a movement of the indoor unit, and a line folding guide disposed to be folded at a constant angle along the bulkhead plate in the loading space and fixing the cold circulation line to prevent the cold circulation line from sagging during the movement of the indoor unit.

### TECHNICAL FIELD

The present disclosure relates to a cooling structure of cargo vehicles, and more specifically, relates to a variable refrigeration tower which may flexibly secure a cold circulation region in a loading space of cargo vehicles for refrigerated or frozen transportation and may improve energy efficiency.

### BACKGROUND ART

As online delivery of fresh food products increases, a cold chain market shows a high growth rate. In particular, refrigerated and freezer vehicles which are responsible for freshness of products during a transportation stage in production-storage-transport stages which are main processes of a cold chain play an important role in delivering safe food to consumers.

In general, the refrigerated and freezer vehicles are cargo vehicles equipped with facilities for maintaining a low temperature below a freezing point to freshly store a cargo during transport or to freshly transport the cargo, and are vehicles manufactured so that an interior of a loading box of general cargo vehicles may be refrigerated or frozen. A cooling device installed in the refrigerated and freezer vehicles may be configured to discharge cooled air from a front part to a rear part inside the loading box. However, most loading spaces are installed to be excessively large, compared to a discharge amount of the cooled air of the cooling device. Consequently, the cooled air discharged from the cooling device does not reach a rear part of the loading space, thereby causing a disadvantage in that cooling efficiency is degraded. In addition, when a cooling output of the cooling device is increased to cool the whole loading space, there is a disadvantage in that electric energy consumption increases.

Recently, as electric vehicles are widely used for the refrigerated and frozen vehicles, refrigerators may be activated by batteries mounted on the vehicles. However, when refrigerator efficiency is maximized to activate the refrigerators, battery consumption may increase, and driving performance may be degraded. For example, in a case of a one ton electric vehicle, when the battery is charged to 100%, the vehicle may travel up to 177 km. However, the refrigerator efficiency is maximized to activate the refrigerator, battery efficiency may decrease, and the vehicle may travel a distance of 150 km or shorter.

Therefore, it is desirable to develop a cooling technology for cargo vehicles which may reduce energy consumption while improving cooling efficiency.

### PRIOR ART DOCUMENT

### Patent Document 1

Korean Patent No. 10-2533081 (May 11, 2023)

### DETAILED DESCRIPTION OF INVENTION

### Technical Problems

One embodiment of the present disclosure is to provide a variable refrigeration tower which may flexibly secure a cold circulation region in a loading space of cargo vehicles for refrigerated or frozen transportation and may improve energy efficiency.

One embodiment of the present disclosure is to provide a variable refrigeration tower which may minimize an energy loss and may maximize cooling efficiency by horizontally moving a bulkhead plate in accordance with loading and unloading of a cargo in the loading space of the cargo vehicle and adjusting a cooling section in accordance with a cargo transport amount.

One embodiment of the present disclosure is to provide a variable refrigeration tower in which an indoor unit is installed in a bulkhead plate and a cold circulation line between an outdoor unit and an indoor unit may be folded in accordance with a horizontal movement of the bulkhead plate.

### Technical Solution

In embodiments, a variable refrigeration tower includes a cargo horizontal loading and unloading unit installed on a floor of a loading box of a cargo vehicle and horizontally moving in a loading space inside the loading box to automatically load and unload a cargo, a bulkhead plate vertically mounted on the loading space to form a bulkhead and horizontally moving inside the loading space in conjunction with the cargo horizontal loading and unloading unit, an outdoor unit installed outside the loading space, an indoor unit disposed in the bulkhead plate, moving along the bulkhead plate and discharging cold air into a first space partitioned by the bulkhead plate in the loading space to form a cold circulation region, a cold circulation line connecting the outdoor unit and the indoor unit and following a movement of the indoor unit, and a line folding guide disposed to be folded at a constant angle along the bulkhead plate in the loading space and fixing the cold circulation line to prevent the cold circulation line from sagging during a process of following the movement of the indoor unit.

The cargo horizontal loading and unloading unit may include a base plate, a drive chain belt configured to include mutually separated chains, at least a portion of which is always exposed to an upper part on the base plate, a passive cover joined to both ends of the drive chain belt in a planar configuration, at least portion of which is exposed to a lower part, surrounding the base plate together with the drive chain belt, and configured to have a length of 80% to 120% of a length of the drive chain belt, a drive shaft joined to a gear of the drive chain belt at a first stage of the base plate, and transmitting a driving force in a first direction to an upper part of the drive chain belt during a loading process, or transmitting the driving force in a second direction to a lower part of the drive chain belt during an unloading process, a passive shaft closely joined to the passive cover at a second stage of the base plate and passively operated by a movement of the passive cover, and a driver providing the driving force in the first direction or in the second direction to the drive shaft.

The drive chain belt may be configured to include a plurality of chain belts each connected to the gear, may be operated while at least a portion is always exposed to the upper part of the base plate during a process of providing the driving force in the first direction or in the second direction, and may fix the bulkhead plate to an upper exposed portion connected to the passive cover.

The bulkhead plate may divide the loading space into a first space where the cargo is loaded and unloaded and a second space where the cargo is not loaded and unloaded, may gradually move to a front surface of the loading space in accordance with loading of the cargo so that the first space is gradually widened, and may gradually move to a rear surface of the loading space in accordance with unloading of the cargo so that the first space is gradually narrowed.

In embodiments, the variable refrigeration tower may further include a sealing member joined along a perimeter of the bulkhead plate and closely adhering to an inner wall surface and a ceiling surface of the loading space to prevent a leakage of the cold air.

The cold circulation line may be formed to be at least longer than a length of the loading space, and may be formed in a form of a hose having a flexible material.

The line folding guide may include two folding frames connected by a hinge bracket so that the two folding frames are mutually pivotable, and both side ends of the folding frame each may be joined to the loading surface of the outdoor unit side and the bulkhead plate to be pivotable through the hinge bracket.

The line folding guide may fix the cold circulation line to an outside of the folding frame, or may accommodates the cold circulation line inside the folding frame to prevent sagging of the cold circulation line, and may guide the cold circulation line to follow the indoor unit.

### Effect of Invention

The disclosed technology may have the following advantageous effects. However, it does not mean that a specific embodiment must include all of the following advantageous effects or must include only the following advantageous effects. Therefore, the scope of the disclosed technology should not be construed as being limited thereby.

The variable refrigeration tower according to one embodiment of the present disclosure may flexibly secure a cold circulation region in a loading space of a cargo vehicle for refrigerated or frozen transportation and may improve energy efficiency.

The variable refrigeration tower according to one embodiment of the present disclosure may minimize an energy loss and may maximize cooling efficiency by horizontally moving a bulkhead plate in accordance with loading and unloading of a cargo in a loading space of a cargo vehicle and adjusting a cooling section in accordance with a cargo transport amount.

In the variable refrigeration tower according to one embodiment of the present disclosure, an indoor unit may be installed in a bulkhead plate, and a cold circulation line between an outdoor unit and the indoor unit may be folded in accordance with a horizontal movement of the bulkhead plate.

### BRIEF DESCRIPTION OF THE DRAWING

FIG. 1 is a diagram showing a variable refrigeration tower according to one embodiment of the present disclosure.

FIG. 2 is a diagram showing a variable space state of the variable refrigeration tower in FIG. 1.

FIG. 3 is a diagram for describing a structure of a cargo horizontal loading and unloading unit in FIG. 1.

FIG. 4 is a diagram for describing a bulkhead plate in FIG. 1.

FIG. 5 is a diagram for describing a process in which cargo horizontal loading and unloading operations are performed in the variable refrigeration tower according to the present disclosure.

FIG. 6 is a diagram for describing a cooling operation in accordance with a space variation in the variable refrigeration tower according to the present disclosure.

### BEST MODE FOR CARRYING OUT THE INVENTION

Since description of the present disclosure is merely an embodiment for structural and functional description, the scope of the rights of the present disclosure should not be construed as being limited by embodiments described herein. That is, since the embodiments may be modified in various ways, and may have various forms, the scope of the rights of the present disclosure should be understood to include equivalents that may realize the technical idea. In addition, it does not mean that a specific embodiment must include all of an object or advantageous effects presented in the present disclosure or must include only the advantageous effects. Therefore, the scope of the rights of the present disclosure should not be understood as being limited thereby.

Meanwhile, meanings of terms described in the present application should be understood as follows.

Terms of “first”, “second”, and the like are intended to distinguish one component from another component, and the scope of the rights should not be limited by these terms. For example, a first component may be referred to as a second component, and similarly, the second component may also be referred to as the first component.

When it is described that a certain component is “connected” to another component, it should be understood that the certain component may be directly connected to the other component, but still another component may exist therebetween. On the other hand, when it is described that a certain component is “directly connected” to another component, it should be understood that still another component does not exist therebetween. Meanwhile, other expressions for describing a relationship between components, that is, “between” and “directly between” or “adjacent to” and “directly adjacent to” should be construed in the same way.

A singular expression should be understood to include a plural expression unless the context clearly indicates otherwise, and terms of “including” or “having” are intended to specify the presence of embodiment features, numbers, steps, operations, components, parts, or combination thereof, and should be understood not to exclude a possibility of the presence or addition of one or more other features, numbers, steps, operations, components, parts, or combinations thereof.

In respective steps, identifiers (for example, a, b, c, and the like) are used for convenience of description, and the identifiers do not describe the order of the respective steps, and the respective steps may occur in an order different from a described order unless the context clearly indicates a specific order. That is, the respective steps may occur in an order the same as the described order, may be substantially simultaneously, performed, or may be performed in the opposite order.

Unless otherwise defined, all terms used herein have the same meaning as those commonly understood by a person of ordinary skill in the art to which the present disclosure belongs. Terms defined in commonly used dictionaries should be construed as having a meaning consistent with the contextual meaning of the relevant art, and should not be construed as having an idealized or overly formal meaning unless explicitly defined in the present application.

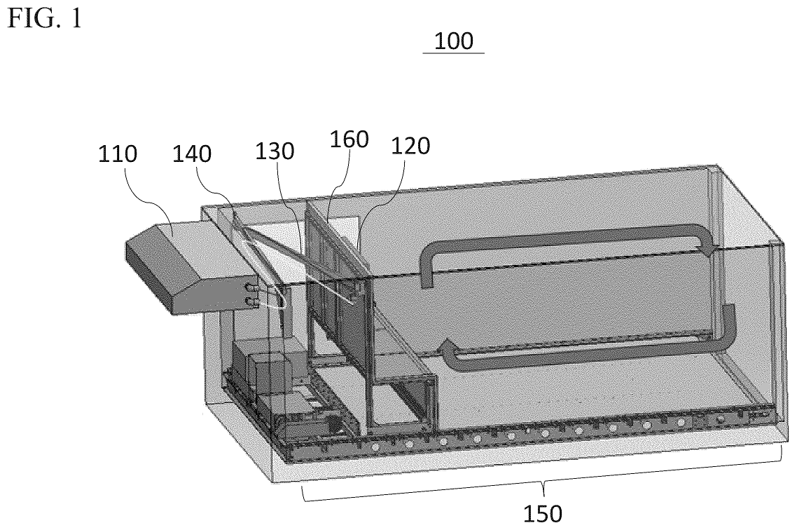

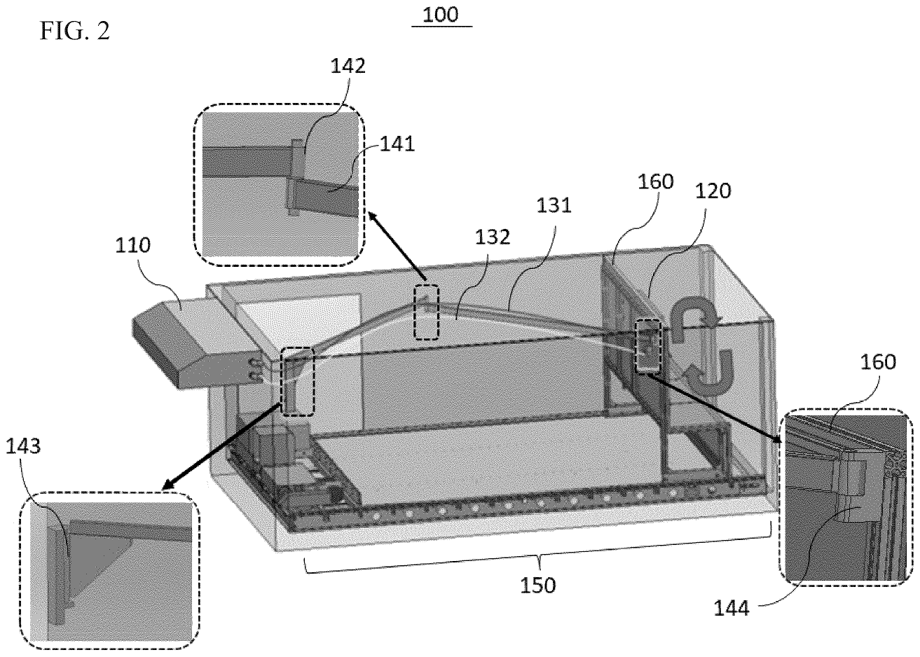

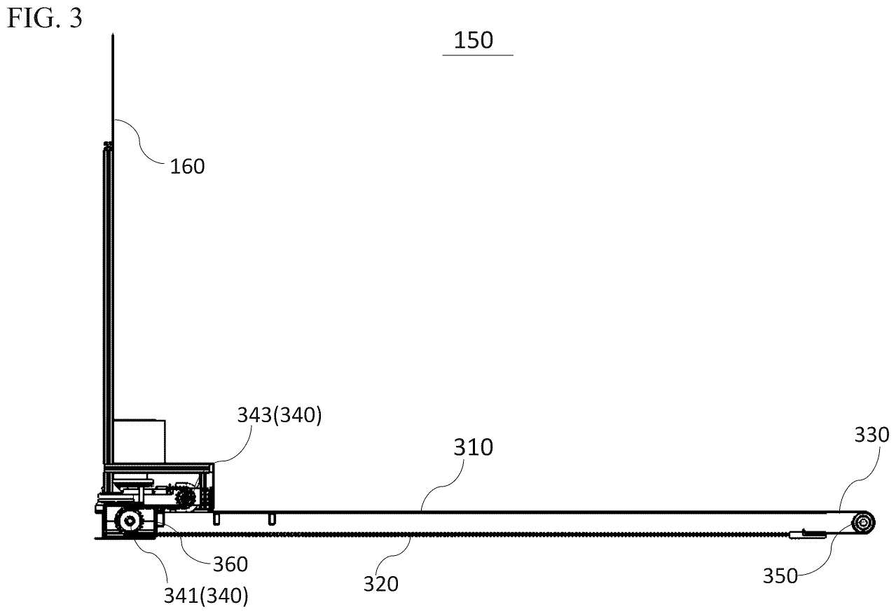

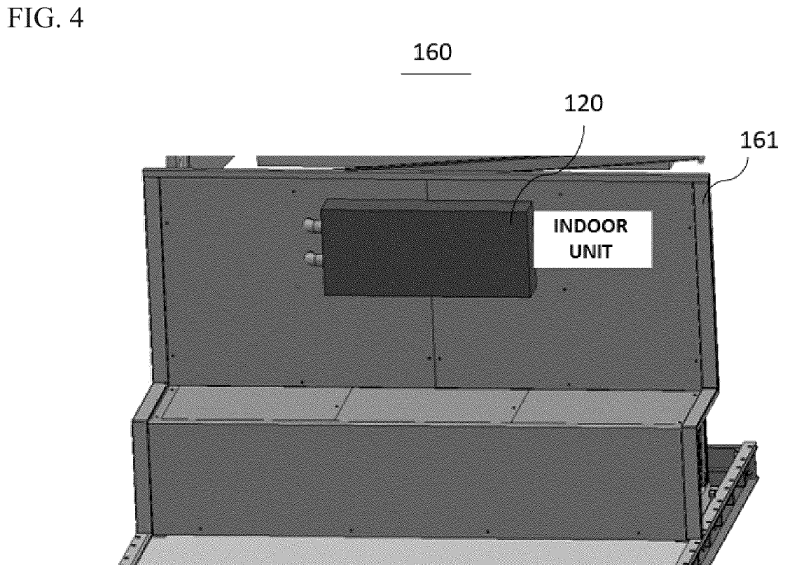

FIG. 1 is a diagram showing a variable refrigeration tower according to one embodiment of the present disclosure. FIG. 2 is a diagram showing a variable space state of the variable refrigeration tower in FIG. 1. FIG. 3 is a diagram for describing a structure of a cargo horizontal loading and unloading unit in FIG. 1. FIG. 4 is a diagram for describing a bulkhead plate in FIG. 1.

Referring to FIGS. 1 to 4, a variable refrigeration tower (100) is installed in a loading space of a cargo vehicle so that a cooling circulation region may be widened and narrowed, and for this purpose, may include an outdoor unit (110), an indoor unit (120), a cooling circulation line (130), a line folding guide (140), a cargo horizontal loading and unloading unit (150), a bulkhead plate (160), and a control unit (not shown).

The outdoor unit (110) is installed outside the loading space of the cargo vehicle. In the cargo vehicle, a front side is provided with a driver's seat for a driver to ride in, and a rear side is provided with a loading box internally having the loading space to load the cargo. In general, the refrigeration tower is mounted on a vehicle body of the cargo vehicle, and each surface of the loading box formed of sandwich panels in a box shape is manufactured with insulation panels. In one embodiment, the outdoor unit (110) may be disposed between the driver's seat and the loading box, but is not necessarily limited thereto. The outdoor unit (110) may be disposed at various positions outside the loading box, such as a wind deflector mounted on a vehicle roof. The outdoor unit (110) may include a compressor that compresses a refrigerant to produce a high-temperature and high-pressure gaseous refrigerant and a condenser serving as a device that condenses and liquefies the gaseous refrigerant.

The indoor unit (120) is installed in the bulkhead plate (160) of the loading space of the cargo vehicle. In one embodiment, the indoor unit (120) may be installed on one surface of the bulkhead plate (160) to discharge cool air to a rearward side where the back door is located in the cargo vehicle. A position of the indoor unit (120) may be adjusted inside the loading space by the bulkhead plate (160) horizontally moving in the loading space. The indoor unit (120) may include an expansion valve that reduces a pressure of a high-pressure liquid by causing the high-pressure liquid to pass through a narrow capillary tube, and a cooling coil that absorb surrounding heat by causing a refrigerant passing therethrough to evaporate after coming into contact with warm indoor air.

The outdoor unit (110) and the indoor unit (120) may be connected via the cold circulation line (130). The cold circulation line (130) may be configured to include a first line (131) connecting the compressor of the outdoor unit (110) and the expansion valve of the indoor unit (120) and a second line (132) connecting the condenser of the outdoor unit (110) and the cooling coil of the indoor unit (120). In one embodiment, in the cold circulation line (130), one side may be connected to the outdoor unit (110), and the other side may be connected to the indoor unit (120). Here, the cold circulation line (130) may be formed in a form of a hose having a flexible material with a specific length so that the cold circulation line (130) follows the indoor unit (120) whose position is variable in accordance with the movement of the bulkhead plate (160). The length of the cold circulation line (130) may be formed to be longer than the loading space.

The line folding guide (140) may be disposed between the loading surface on the outdoor unit (110) side and the bulkhead plate (160) in the loading space to be foldable along the movement of the bulkhead plate (160), and may fix the cold circulation line (130) to prevent sagging during a process in which the cold circulation line (130) follows the indoor unit (120). In one embodiment, as shown in FIG. 2, the line folding guide (140) may have a folding structure which is foldable at a constant angle around the center. Specifically, the line folding guide (140) may include two folding frames (141 connected by a hinge bracket (142) to be mutually pivotable. Both side ends of the folding frame (141) each are joined to the loading surface and the bulkhead plate (160) through hinge brackets (143 and 144) so that a folding operation is smoothly performed by each rotation of the folding frames (141) on both sides around the hinge bracket (142). Here, the folding frame (141) may be formed in a shape of a metal bar. In this case, the cold circulation line (130) may be fixed to multiple locations outside the folding frame (141) by using a connection member such as a tie-wrap to prevent sagging of the cold circulation line (130). When the folding frame (141) is formed in a shape of a hollow tube, the cold circulation line (130) may be internally accommodated.

The line folding guide (140) may prevent sagging caused by a load, and may guide the cold circulation line (130) to follow the indoor unit (12) whose position is variable along the bulkhead plate (160) by performing folding and unfolding operations in accordance with the moving direction of the bulkhead plate (160).

The cargo horizontal loading and unloading unit (150) may be installed so that the cargo is automatically loaded and unloaded in the loading space of the cargo vehicle. For this purpose, as shown in FIG. 3, the cargo horizontal loading and unloading unit (150) may be implemented by including the base plate (310), the drive chain belt (320), the passive cover (330), the drive shaft (340), the passive shaft (350), and the driver (360).

Specifically, the base plate (310) is formed in a flat plate shape that forms a bottom surface of the loading space in the cargo vehicle. The base plate (310) may correspond to the bottom of the loading box.

The drive chain belt (320) is configured to include mutually separated chains, at least a portion of which is always exposed to the upper part on the base plate (310). In one embodiment, the drive chain belt (320) is disposed on the base plate (310) with a constant length, and rotates and moves along the base plate (310). Here, the drive chain belt (320) is configured to include a plurality of chain belts, and is operated while at least a portion is always exposed to the upper part of the base plate (310).

The passive cover (330) is joined to both ends of the drive chain belt (320) in a planar configuration, surrounds the base plate (310) together with the drive chain belt (320) while at least a portion is exposed to the lower part, and is configured to have the length of 80% to 120% of the length of the drive chain belt (320). That is, the length of the passive cover (330) may be the same as the length of the drive chain belt (320), or may be shorter or longer within a range of 20%. For example, when the length of the drive chain belt (320) is 3,760 mm, based on a one ton cargo vehicle, the passive cover (330) may be configured to have the length of 3,008 mm to 4,512 mm. Since a force of the drive chain belt (320) varies depending on the length, the length of the passive cover (330) is set to 80% to 120% of the length of the drive chain belt (320) so that the passive cover (330) smoothly moves along the drive chain belt (320). In one embodiment, the passive cover (330) is linked to the drive chain belt (320) on both sides, and moves along the drive chain belt (320). The passive cover (330) may be horizontally moved on the base plate (310) by the rotation of the drive chain belt (320) to load and unload the cargo in the loading space. Here, the passive cover (330) may be formed of a plate member having an elastic rubber material, but is not necessarily limited thereto, and may be formed of a flexible material moved along the drive chain belt (320) so that at least a portion is exposed to the lower part of the base plate (310) and at least another portion is exposed to the upper part of the base plate (310). The passive cover (330) may have a structure exposed to the upper part of the base plate (310) and coming into direct contact with the cargo.

The drive chain belt (320) and the passive cover (330) may be joined via the bulkhead plate (160). That is, the bulkhead plate (160) may be fixedly joined to the upper exposed portion to which the drive chain belt (320) and the passive cover (330) are connected.

The drive shaft (340) is joined in gear to the drive chain belt (320) at the first stage of the base plate (310), and transmits the driving force in the first direction to the upper part of the drive chain belt (320) during the loading process, or transmits the driving force in the second direction to the lower part of the drive chain belt (320) during the unloading process. The drive shaft (340) may provide the driving force in the first direction or in the second direction by fastening each of the plurality of chain belts of the drive chain belt (320) in gear. In one embodiment, the drive shaft (340) is configured to include a pair of gears, and the drive chain belt (320) passes between the pair of gears as the gears rotate. Specifically, the drive shaft (340) may include the lower gear (341) connected to the driver (360) and transmitting the driving force provided by the driver (360), and the upper gear (343) receiving the driving force through the lower gear (341) to move the drive chain belt (320). The lower gear (341) is fixedly joined to the first stage of the base plate (310). The upper gear (343) may be operated while being always exposed to the upper part of the base plate (310), and may be fixedly joined to the bulkhead plate (160). The lower gear (341) is configured to have the diameter larger than the upper gear (343). The drive shaft (340) may form the lower part and the upper gears (341 and 343) along a perimeter in the joining region of the drive chain belt (320), may transmit the driving force in the first direction to the upper gear (343) through the lower gear (341) during the loading process, and may transmit the driving force in the second direction to the upper gear (343) through the lower gear (341) during the unloading process. In this case, the upper gear (343) may receive the driving force in the first direction or in the second direction, and may move the drive chain belt (320) while rotating in the corresponding direction.

The passive shaft (350) is joined to the passive cover (330) at the second stage of the base plate (310), and is passively operated in accordance with the movement of the passive cover (330). The passive shaft (350) may be disposed outside the loading space of the cargo vehicle, and may be exposed outward of the loading space regardless of whether the back door of the cargo vehicle is opened or closed. Here, the passive shaft (350) rotates in conjunction with the drive shaft (340) axially rotated by the driver (360). The passive shaft (350) is configured to protrude rearward of the cargo vehicle so that a volume loss of the loading space is minimized and connection to the other cargo vehicle is available.

The driver (360) provides the driving force in the first direction or in the second direction to the drive shaft (340). The driver (360) may be axially joined to the drive shaft (340) at the first stage of the base plate (310). The driver (360) may use a hydraulic motor, but is not necessarily limited thereto, and may be any driving motor capable of providing the driving force to the drive shaft (340). The driver (360) may move the drive shaft (340) to the upper part or the lower part by a specific angle during a process of initially providing the driving force, and may provide a relatively strong driving rotational force. Here, the specific angle may be an angle of 10 degrees or smaller not to interfere with supporting the drive shaft (340).

The bulkhead plate (160) may be vertically mounted on the loading space of the cargo vehicle to form the bulkhead. In the bulkhead plate (160), the upper exposed end of the drive chain belt (320) may be joined to one side of the lower part and the upper exposed end of the passive cover (330) may be joined to the other side of the lower part so that the bulkhead plate (160) moves in the same direction as that of the passive cover (330) along the drive chain belt (320). In this case, the bulkhead plate (160) may support the cargo loaded and unloaded on the passive cover (330) in the loading and unloading direction so that the cargo is stably loaded and unloaded. In one embodiment, the bulkhead plate (160) horizontally moves inside the loading space in conjunction with the cargo horizontal loading and unloading unit (150). Specifically, the bulkhead plate (160) horizontally moves inside the loading space of the cargo vehicle in conjunction with the passive cover (330). The bulkhead plate (160) loads or unloads the cargo on the passive cover (330) while horizontally moving. The bulkhead plate (160) may be formed of a metal plate. The bulkhead plate (160) may partition the loading space into a space where the cargo is not loaded and a space where the cargo is loaded. The bulkhead plate (160) may gradually move to the front surface of the loading space in accordance with the loading of the cargo, and may gradually move to the rear surface of the loading space in accordance with the unloading of the cargo. Accordingly, the partitioned space may vary. In this case, the indoor unit (120) may be installed in the bulkhead plate (160) so that the cold circulation region is flexibly determined by space partitioning of the bulkhead plate (160). Here, the cold circulation region may be defined as a partial space where the cargo is actually loaded, rather than the entire loading space inside the loading box.

The bulkhead plate (160) may include a sealing member (161) joined along a perimeter as shown in FIG. 4, and closely adheres to an inner wall surface of the loading box of the vehicle to prevent a cold air leakage. Here, the sealing member (161) may be formed of a silicone material. In one embodiment, the sealing member (161) may be joined to the bulkhead plate (160) by a fastening member such as a bolt. The sealing member (161) closely adheres to the inner wall surfaces and the ceiling surface on both sides of the loading box when the bulkhead plate (160) horizontally moves, thereby maintaining airtightness. In this manner, cold reserving efficiency may be improved by preventing cold air from escaping through a gap between the loading box and the bulkhead plate (160).

A control unit (not shown) controls an overall operation of the variable refrigeration tower (100) in accordance with an operation of a user through electrical connection to perform horizontal loading and unloading operations of the cargo, and adjusts the cold circulation region by causing a refrigeration tower space to be variable in accordance with the loading and unloading of the cargo.

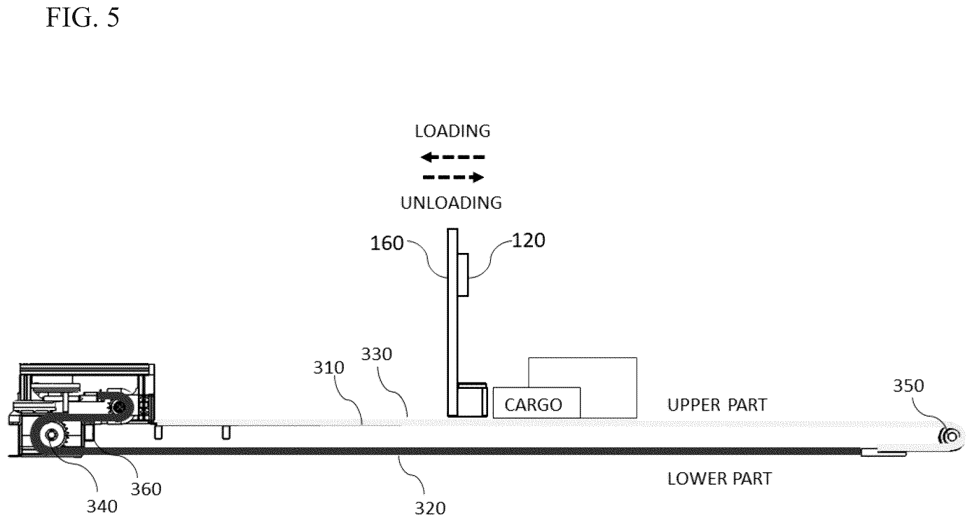

FIG. 5 is a diagram for describing a process in which the cargo horizontal loading and unloading operations are performed in the variable refrigeration tower according to the present disclosure.

Referring to FIG. 5, the variable refrigeration tower (100) drives the driver (360) of the cargo horizontal loading and unloading unit (150) to provide the driving force in the first direction or in the second direction to the drive shaft (340). In this manner, the variable refrigeration tower (100) drives the driver (360) may operate the drive chain belt (320) to perform the horizontal loading and unloading operations of the cargo.

When the loading operation of the cargo vehicle is performed, first, the loading space of the cargo vehicle is opened, and the cargo is loaded onto the passive cover (330) exposed on the base plate (310). During the loading process, the drive shaft (340) is axially rotated through the driver (360) to transmit the driving force in the first direction to the drive chain belt (320). During a process of initially providing the driving force, the driver (360) moves the drive shaft (340) to the lower part by a specific angle so that a relatively strong driving rotational force is provided. The drive chain belt (320) is joined in gear to the drive shaft (340), and moves as the upper gear (343) is rotated by the driving force in the first direction to gradually move the passive cover (330) to the front surface of the loading space. The passive cover (330) may always be exposed to the upper part of the base plate (310) by moving to the front surface of the loading space in a state where the cargo is loaded along the drive chain belt (320). That is, the passive cover (330) may come into direct contact with the cargo, and may move the cargo to the front surface of the loading space so that the cargo is sequentially loaded from the front surface of the loading space. In this case, the bulkhead plate (160) fixedly joined to the upper exposed portion to which the drive chain belt (320) and the passive cover (330) are connected moves together with the passive cover (330) in accordance with the rotation of the drive chain belt (320) to support the cargo loaded on the passive cover (330) so that the cargo is stably placed. When the loading operation of the cargo is completed, the driving of the driver (360) is stopped, and the loading space is closed. Finally, the outdoor unit (110) and the indoor unit (120) are operated to discharge the cold air into the space where the cargo is loaded, and thereafter, a transport operation is performed.

When the unloading operation of the cargo vehicle is performed, first, the loading space of the cargo vehicle is opened, and the cargo loaded in the loading space is unloaded. In the unloading process, the driving force a in the second direction opposite to the first direction in the loading process is provided to the drive chain belt (320) through the driver (360). The passive cover (330) is joined to the upper exposed end and the lower exposed end of the drive chain belt (320), and the passive cover (330) moves along the drive chain belt (320). The drive chain belt (320) may horizontally pull the passive cover (330) so that the cargo loaded on the passive cover (330) horizontally moves on the base plate (310) of the loading space. The drive shaft (340) may transmit the driving force of the driver (360) to the drive chain belt (320) to rotate the drive chain belt (320) so that the passive cover (330) joined to the drive chain belt (320) horizontally moves to discharge the cargo placed on the upper part outward of the rear surface of the loading space. The drive chain belt (320) is rotated by the drive shaft (340) rotated in accordance with the rotation of the driver (360). The passive cover (330) joined to the drive chain belt (320) comes into contact with the passive shaft (350) which is at least partially exposed outward of the rear surface of the loading space, and moves to the lower part of the base plate (310). That is, when the drive chain belt (320) rotates in the second direction in a state where the cargo is loaded on the upper exposed portion of the base plate (310), a pulling force is applied to the passive cover (330) joined to the drive chain belt (320) so that the passive cover (330) horizontally moves outward of the rear surface of the loading space. In a process in which the passive cover (330) horizontally moves outward of the rear surface of the loading space, the bulkhead plate (160) is moved together to support the cargo loaded on the upper part of the passive cover (330) so that the cargo does not fall toward the front surface of the loading space. The passive cover (330) is guided to move to the lower part of the base plate (310) by the passive shaft (350) which is at least partially exposed outward of the rear surface of the loading space, and the cargo is automatically discharged outward of the rear surface of the loading space. When the unloading operation of the cargo is completed, the driving of the driver (360) is stopped, and the loading space is closed. Finally, as the cargo is unloaded, an occupancy rate of the cargo inside the loading space decreases, and a cooling section defined by the bulkhead plate (160) decreases. Therefore, a cooling driver is operated accordingly to adjust the cold air.

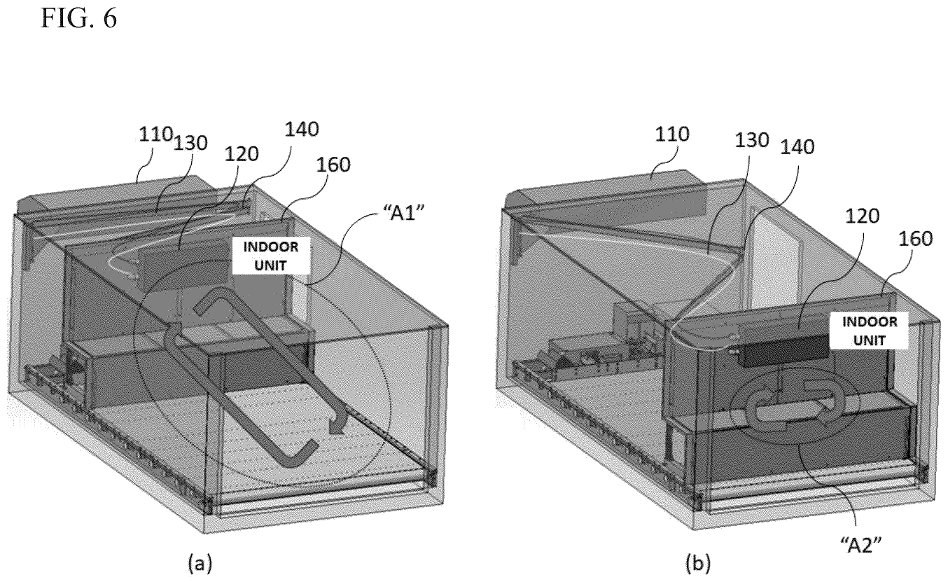

FIG. 6 is a diagram for describing a cooling operation in accordance with a space variation in the variable refrigeration tower according to the present disclosure.

Referring to FIG. 6, the variable refrigeration tower (100) may widen or narrow the cooling section inside the loading space of the cargo vehicle in accordance with the horizontal movement of the bulkhead plate (160). As shown in (a) of FIG. 6, a section to be cooled is widened as the bulkhead plate (160) approaches the front surface of the loading space (A1). On the other hand, as shown in (b) of FIG. 6, the section to be cooled is narrowed as the bulkhead plate (160) approaches the rear surface of the loading space (A2). The indoor unit (120) may be installed in the bulkhead plate (160) to always be disposed in the corresponding cooling section even when the cooling section is widened or narrowed. Here, the space inside the loading box may be divided into a first space adjacent to the front surface of the bulkhead plate (160) on which the indoor unit (120) is installed and a second space adjacent to the rear surface of the bulkhead plate (160). The first space and the second space may be variable in size in accordance with the horizontal movement of the bulkhead plate (160).

The variable refrigeration tower (100) maintains connection between the outdoor unit (110) and the indoor unit (120) in such a manner that the line folding guide (140) performs the folding operation to fold or unfold the cold circulation line (130) in accordance with the movement of the bulkhead plate (160). When the bulkhead plate (160) moves toward the front surface of the loading space, the center of the folding frame (141) on both sides is folded, and the line folding guide (140) is gathered by the hinge brackets (142, 143, and 144). On the other hand, when the bulkhead plate (160) moves toward the rear surface of the loading space, the center of the folding frames (141) on both sides is unfolded and spread to both sides by the hinge brackets (142, 143, and 144). In this case, a folding degree of the line folding guide (140) may be determined depending on a moving distance of the bulkhead plate (160).

The variable refrigeration tower (100) may circulate the cold air in the first space by feeding air introduced from the first space through the indoor unit (120) to the outdoor unit (110) through the cold circulation line (130) and discharging the cooled air through the outdoor unit (110) to the first space through the indoor unit (120). The variable refrigeration tower (100) may lower a temperature by circulating the cold air in the first space.

According to the present disclosure, the variable refrigeration tower may improve both cooling efficiency and energy efficiency in such a manner that the refrigeration tower space is narrowed as the cargo is unloaded inside the loading box of the cargo vehicle.

Hitherto, the present disclosure has been described with reference to preferred embodiments. Meanwhile, it may be understood by those skilled in the art that the present disclosure may be corrected and modified in various ways within the scope not departing from the concept and the range of the present disclosure described in the appended claims.

### DESCRIPTION OF REFERENCE NUMERALS

100: variable refrigeration tower
110: outdoor unit
120: indoor unit
130: cooling circulation line
131: first line
132: second line
140: line folding guide
84141: folding frame
142,143,144: hinge bracket
150: cargo horizontal loading and unloading unit
160: bulkhead plate
161: sealing member
310: base plate
320: drive chain belt
330: passive cover
340: drive shaft
341: lower gear
343: upper gear
350: passive shaft
360: driver

What is claimed is:

1. A variable refrigeration tower comprising:
a cargo horizontal loading and unloading unit installed on a floor of a loading box of a cargo vehicle and horizontally moving in a loading space inside the loading box to automatically load and unload a cargo;
a bulkhead plate vertically mounted on the loading space to form a bulkhead and horizontally moving inside the loading space in conjunction with the cargo horizontal loading and unloading unit;
an outdoor unit installed outside the loading space;
an indoor unit disposed in the bulkhead plate, moving along the bulkhead plate and discharging cold air into a first space partitioned by the bulkhead plate in the loading space to form a cold circulation region;
a cold circulation line connecting the outdoor unit and the indoor unit and following a movement of the indoor unit; and
a line folding guide disposed to be folded at a constant angle along the bulkhead plate in the loading space and fixing the cold circulation line to prevent the cold circulation line from sagging during a process of following the movement of the indoor unit.

2. The variable refrigeration tower of claim 1, wherein the cargo horizontal loading and unloading unit includes a base plate, a drive chain belt configured to include mutually separated chains, at least a portion of which is always exposed to an upper part on the base plate, a passive cover joined to both ends of the drive chain belt in a planar configuration, at least portion of which is exposed to a lower part, surrounding the base plate together with the drive chain belt, and configured to have a length of 80% to 120% of a length of the drive chain belt, a drive shaft joined to a gear of the drive chain belt at a first stage of the base plate, and transmitting a driving force in a first direction to an upper part of the drive chain belt during a loading process, or transmitting the driving force in a second direction to a lower part of the drive chain belt during an unloading process, a passive shaft closely joined to the passive cover at a second stage of the base plate and passively operated by a movement of the passive cover, and a driver providing the driving force in the first direction or in the second direction to the drive shaft.

3. The variable refrigeration tower of claim 2, wherein the drive chain belt is configured to include a plurality of chain belts each connected to the gear, is operated while at least a portion is always exposed to the upper part of the base plate during a process of providing the driving force in the first direction or in the second direction, and fixes the bulkhead plate to an upper exposed portion connected to the passive cover.

4. The variable refrigeration tower of claim 1, wherein the bulkhead plate divides the loading space into a first space where the cargo is loaded and unloaded and a second space where the cargo is not loaded and unloaded, gradually moves to a front surface of the loading space in accordance with loading of the cargo so that the first space is gradually widened, and gradually moves to a rear surface of the loading space in accordance with unloading of the cargo so that the first space is gradually narrowed.

5. The variable refrigeration tower of claim 1, further comprising:
a sealing member joined along an edge of the bulkhead plate and closely adhering to an inner wall surface and a ceiling surface of the loading space to prevent a leakage of the cold air.

6. The variable refrigeration tower of claim 1, wherein the cold circulation line is formed to be at least longer than a length of the loading space, and is formed in a hose form having a flexible material.

7. The variable refrigeration tower of claim 1, wherein the line folding guide includes two folding frames connected by a hinge bracket so that the two folding frames are mutually pivotable, and both side ends of the folding frame each are joined to the loading surface of the outdoor unit side and the bulkhead plate to be pivotable through the hinge bracket.

8. The variable refrigeration tower of claim 7, wherein the line folding guide fixes the cold circulation line to an outside of the folding frame, or accommodates the cold circulation line inside the folding frame to prevent sagging of the cold circulation line, and guides the cold circulation line to follow the indoor unit.
